(19) United States
(12) Patent Application Publication
(10) Pub. No.: US 2026/0321135 A1
(43) Pub. Date: Oct. 15, 2026

(54) Truck Over-Height Alarm

(71) Applicant: James A. Baldwin, North Syracuse, NY (US)

(72) Inventor: James A. Baldwin, North Syracuse, NY (US)

(21) Appl. No.: 19/175,199

(22) Filed: Apr. 10, 2025

(51) Int. Cl. G08G 1/095; G08G 1/01

(52) U.S. Cl. CPC G08G 1/095; G08G 1/0104

(57) ABSTRACT

An alarm arrangement detects whether a vehicle leaving a work site is above a safe height limit, and produces audible and/or visible alarms. A cable attached to elevated anchor points, with attached tensioner spring and an actuator cable, pulls the alarm(s) ON if a leaving vehicle is over-height.

The present invention is directed to an alarm arrangement that can detect whether a vehicle is above a predetermined maximum safe height for roadway use, that is, whether the vehicle is below or above a height limit so that the vehicle may safely pass beneath a bridge or other overhead obstruction. In particular, the invention provides an alarm to warn a truck leaving a site with a load of gravel, pavement materials, or the like, without lowering the truck box to its lowered position. Typically, commercial vehicles have a height limit of thirteen-and-one-half feet, and are required to be at or below that height limit. The concept of this invention is described briefly below.

The invention concerns a means of physically engaging a truck body or box as the truck begins to leave the facility, if the box is in a raised position or is otherwise too high for driving on a public road. Embodiments of the invention will alarm if some portion of the truck contents or equipment, for example, a crane, is raised above the height limit.

Trucks used for delivery of gravel or other particulate matter have a container compartment or “box” that is normally in a down position for receiving material and for transport, but which can be elevated or tipped to a raised position to allow the material to pour out the back at the delivery site. Before leaving the delivery site, the truck has to have the box returned to the lowered position for travel on public roadways. If the truck is driven with the box in the up position, it extends higher than the elevation of many overhead obstructions such as bridges (which are required have a clearance of a nominal 13 feet six inches but fourteen feet in some states). When a vehicle leaves with the box raised to any position above a clearance limit, travel or transport can result in a bridge strike, causing damage to the bridge as well as the truck.

Here, the object of the invention is to place a detector and alarm arrangement at or before the exit from a construction yard onto public roadways, so that if a truck passes with the box above a height limit, the alarm will sound to notify the driver and others working that yard that the truck is too high. This gives the driver a chance to return the truck's box to the lowered position before he leaves the yard, and before any resulting damage occurs.

The alarm system comprises a cable, cord, or rope that has its ends elevated to a suitable height, e.g. between twelve and fourteen feet, with one end fixed and the other going to a switch device that is actuated when the cable can be pulled out or away from it. This sends electricity to one or more alarm horns. The cable is situated across and above an exit lane from a site or yard. If a truck leaves after delivery with the box up (i.e., going up over the thirteen and one-half-foot limit) it will catch the cable and set off the alarm. If the truck has the box lowered, as it is supposed to be when leaving, it will pass under the cable without incident. Favorably, there is a spring connected to the second end of the cable to keep some tension on it, but permit the cable to be pulled out by a too-high truck box. The arrangement also includes cable release and reset features, which permit a short, quick set up after an alarm incident.

A reset switch allows the alarm to be shut off when the truck is stopped after setting off the alarm. Then the operator can put the second end of the cable, or a plug like device on it, into the switch device, with the cable just above the height limit.

The electronics, batteries, horns etc can fit into a small portable case. The customer can easily place posts, vertical rails, or other high members on either side of the exit drive for mounting the cable at the elevation limit.

In a favorable embodiment of the invention, the arrangement adapted for detecting whether a vehicle passing on a driveway or passageway is above a predetermined height limit. First and second anchor members affixed upon first and second vertical stanchions are disposed on opposite sides of the driveway or passage way, each at a height above the driveway or passageway corresponding to the safe height limits. The stanchions may include posts or rails or may be existing structure such as the wall of a building or a fence. A flexible inextensible cable has a first end affixed to said first anchor member, and a second end. A tensioner arrangement is attached between the second end of the flexible inextensible cable and the second anchor member.

The tensioner arrangement can include an extensible coil spring member, a release ring connecting one end of the spring member to the second end of the flexible inextensible cable, and a clamp connecting a second end of the spring member to the second anchor member. The spring maintains tension in the flexible inextensible cable such that the latter extends substantially horizontally at or near the height limit.

An actuator is mounted on the second stanchion, and is electrically coupled to a power source and to at least one alarm sounder. The actuator has a switch member for turning on the actuator. Then when the switch member is pulled ON, the actuator provides power from the power source to the alarm sounder(s).

In the preferred arrangement, a flexible actuator cable is coupled between the actuator's switch member and the second end of the flexible inextensible cable. The actuator cable is long enough so that normally (i.e., when no vehicle is present on the driveway or passageway) the actuator cable has a predetermined amount of slack. When a vehicle passes beneath the flexible inextensible cable without engaging the latter, the slack remains and the actuator remains in its OFF condition. On the other hand, if the vehicle passing along that driveway or passageway is over-height, and engages the flexible inextensible cable, the over-height vehicle catches and pulls the flexible cable and actuator cable taking up the slack. At that point, the truck pulls out the cable, and then pulls the switch member of the actuator. The actuator connects the power supply to the sounder(s), and associated visible alarm(s) such as flashers, and produces an alarm audible to the vehicle's driver (and a visible indication as well).

Favorably, the first and second vertical stanchions can be of simple construction, for example, each comprising a weighted base and a vertical member of adjustable height rising from its weighted base. These may be hinged or telescoping, so they can be raised and lowered easily. The anchor members may each include a C-clamp secured to the associated stanchion, a D-ring secured by the C-clamp, and a double-ended snap-hook secured to the associated D-ring.

The tensioner spring may have one end secured to the double-ended snap-hook of the second anchor member, with a release ring securing the other end of the tensioner spring to the second end of said flexible inextensible cable. The release ring, coiled, similar to a key ring, and giving way at a certain amount of pull, will break away when subjected to the force exerted by the truck on the cables. Favorably, the flexible inextensible cable is a wire cable of a nominal 30-foot length, and has wire loops formed at its ends. A number of visibility pennants can hang from the cable at intervals.

In the described embodiment, the actuator cable is connected to the second end (i.e., the tensioner spring end) of the flexible inextensible cable. This starts to pull out the actuator pin or plug after the tensioner spring is stretched to its limit, and the release ring gives way.

The power source can include a rechargeable battery provides power at a predetermined voltage level, and a solar generator provides electrical charging current to the rechargeable battery. No connection to commercial AC power is needed. In addition to the acoustic sounder(s) the system may include at least one light-generating flasher.

The entire system, with the exception of the stanchions, may fit into one or more portable cases whereby the system may be quickly assembled and tested at the site. That is, the arrangement of components in this system facilitates a fast initial set-up, and simple restoration after a hit by a truck with its box raised.

The principles involved in our invention will become apparent from the following detailed description of a preferred embodiment, with reference to the Drawing figures.

### BRIEF DESCRIPTION OF THE DRAWING

FIG. 1 is an environmental view showing the over-eight alarm system according to this invention place at an exit driveway for trucks leaving a construction yard.

FIG. 2 is a general schematic view of the over-height alarm.

FIG. 3 shows an alternate configuration of a portion of the FIG. 2 embodiment.

FIG. 4 shows the various components thereof, laid out before assembly.

### DETAILED DESCRIPTION OF THE PREFERRED EMBODIMENT

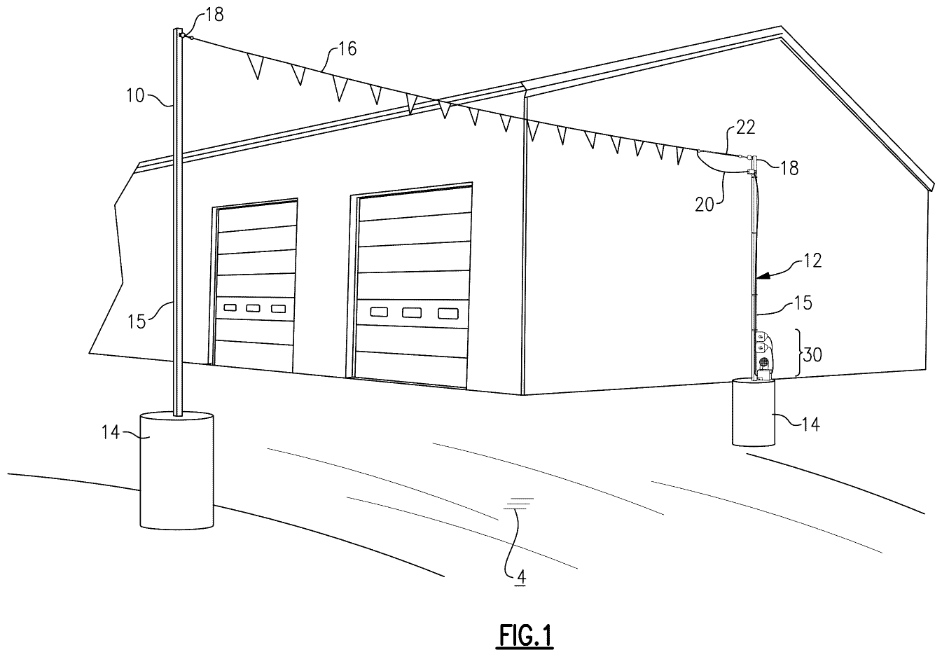

FIG. 1 is an environmental view of a typical construction site with an exit drive 4 by which vehicles can leave the site after deposing a load of gravel or paving material. A vertical stanchion 10 is located along the exit drive 4 on one side and a second vertical stanchion 12 is located opposite the first stanchion on the other side, as shown. Here, each stanchion has a weighted base 14, which can include an oil drum weighted with gravel or sand; each supports a vertical pole or rail 15 that rises up to a predetermined height above the driveway 4, typically thirteen-and-one-half feet or just above that. A flexible, but inextensible cable 16 extends from an anchor member 18 to a tensioner a second or actuator cable 20 and to a tensioner spring 22 that connects to a similar anchor member 18 at the top of the second stanchion 12. An alarm arrangement 30, e.g., sounder(s) and flasher(s), can be positioned on or just above the associated base or drum 14. The tensioner spring keeps tension on the cable 16 so that it stays horizontal or approximately so. Here, pennants are shown at intervals along the cable 16 so its presence can be seen by drivers of the trucks that pass along the driveway 4.

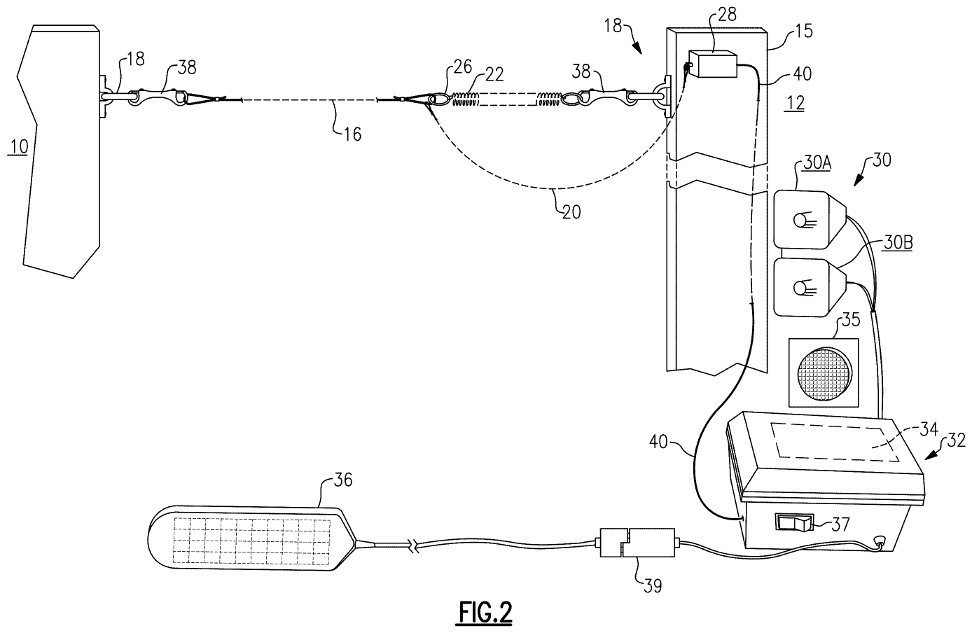

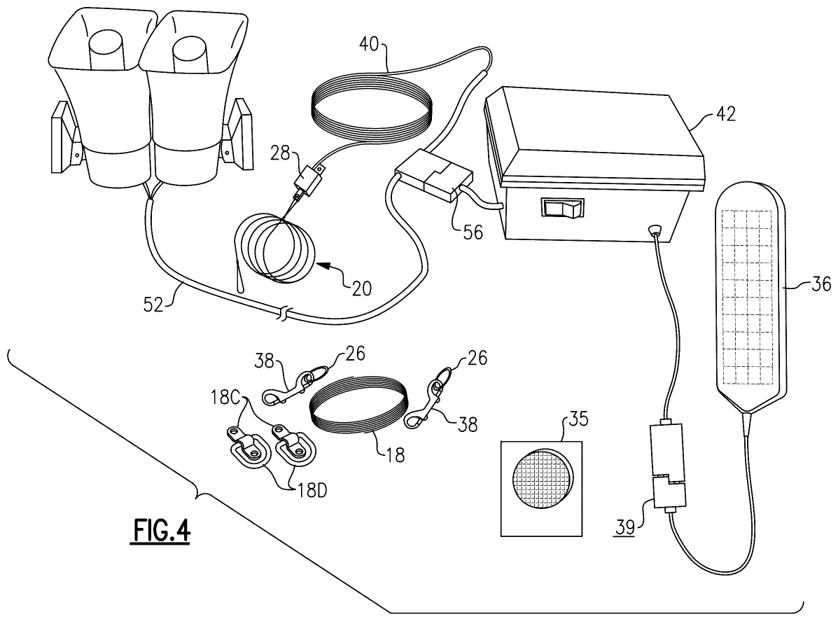

FIG. 2 enlarges portions of the arrangement shown in FIG. 1. At the upper ends of the first and second stanchions 10, 12 the anchor members 18 are formed of a C-clamp 18-C attached to the associated post or rail, and securing a D-ring 18-D (see also FIG. 4). At each location, there is a double-end clamp 38 (FIG. 4) hooked to the as socketed D-ring, with the clamp 38 on the fits stanchion being secured to a loop end of the flexible inextensible cable 16, and with the clamp 38 at the other stanchion 12 connected via a release ring 26 to one end of the tensioner spring 22. The other end of the spring is connected via a release ring to the wire loop at the associated end of the cable 16.

The actuator cable 20 is connected between that end of the cable 16 and an actuator 28 that is shown here being affixed to the upper end of the second stanchion 12. With its included slack, he actuator cable 20 normally hangs in a loop that is positioned to the outside of the pathway of the truck box.

A durable plastic case 32 is shown housing a rechargeable battery 34 (illustrated by broken line) and necessary wiring and connections so that it may energize one or more alarm sounders 30A, 30B, and optionally one or more flashers 35. A solar charger 36 is connected via a connector 37 and associated cables to the battery 34. The charger can be positioned in a sunny area, and will supply sufficient energy to keep the battery charged and operate the sirens and sounders when actuated. A reset switch 37 on the case 32 allows the alarms and other items to be reset to their ready condition after an alarm has been sounded.

A power cable 40 extends from the case 32 up to the actuator 28 to carry electric power from the battery, and to provide power to the alarm sounders 30 when he cable 20 has pulled the actuator 28 to ON. In this case, the actuator cable 20 pulls a pin or plug out from the actuator to put the latter into its ON state, and the pin or plug is replaced to reset the actuator to its ready or OFF state.

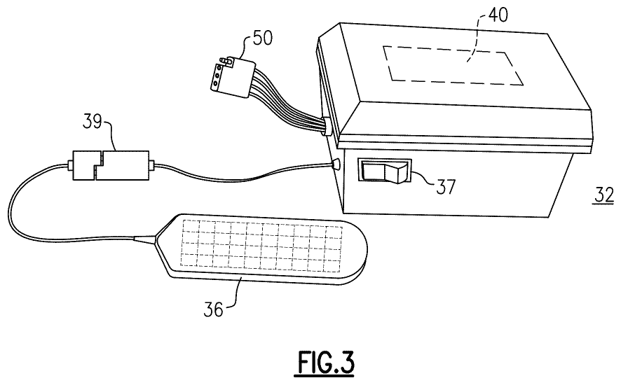

FIG. 3 shows a portion of the arrangement of this embodiment in which a connector 50 is provided to/from the battery 34, so that a single mating connector (FIG. 4) can connect both with the electric cable 40 for the actuator and a separate electric cable 52 to the alarm sounders/flashers.

Normally, when trucks or other vehicles pass along the driveway 4 in their normal, safe condition (with box lowered so as not to exceed the height limit), the vehicle will pass beneath the cable 16 without pulling the cable 16 and the actuator cable 20, and the alarm sounders and flashers are not actuated. However any vehicle on the driveway 4 exceeding the height limit will catch the cable 16 and pull it out so that the actuator cable 20 pulls the actuator 28 ON, sounding the alarm sounders (and energizing the flashers). This is loud enough so that the truck operator hears it clearly, and knows to stop the vehicle immediately and take action to lower the truck box below the height limit. Then the over-height alarm arrangement can be reset and put back into its ready condition for any subsequent vehicles.

In some alternative embodiments, a laser device, e.g., a Lidar, may be employed to assist in detecting whether some portion of the truck or other vehicle is over the height limit when proceeding along the driveway.

The above and many other implementations and advantages of this invention will be apparent to persons of skill in this field, without departing from the principles and elements of this invention, which should be determined from the following Claims.

What is claimed is:

1. Alarm arrangement adapted for detecting whether a vehicle passing on a driveway or passageway is above a predetermined height limit, comprising
first and second anchor members affixed upon first and second vertical stanchions disposed on opposite sides of said driveway or passage way, and each said anchor member being at a height above the driveway or passageway corresponding to said height limits;
a flexible inextensible cable having a first end affixed to said first anchor member, and a second end;
a tensioner arrangement that is affixed to the second end of said flexible inextensible cable and to said second anchor member;
the tensioner arrangement including an extensible spring member, a release ring connecting one end of the spring member to the second end of said flexible inextensible cable, and a clamp connecting a second end of the spring member to the second anchor member, the spring maintaining tension in said flexible inextensible cable such that the latter extends substantially along a level at or near said height limit;
an actuator mounted on said second stanchion, and electrically coupled to a power source and to at least one alarm sounder; said actuator having a switch member for turning on said actuator such that when on the actuator provides power from said power source to said at least one alarm sounder;
a flexible actuator cable coupled between the switch member on said actuator and said second end of said flexible inextensible cable; such that when no vehicle is present on the driveway or passageway the actuator cable includes a predetermined amount of slack; such that when a vehicle passes beneath the flexible inextensible cable without engaging the latter, the slack remains and the actuator remains in its OFF condition; but if the vehicle passing on said driveway or passageway is overheight, and engages the flexible inextensible cable, the overheight vehicle pulls the flexible cable and pulls the actuator cable taking up said slack and pulling the switch member of the actuator, such that the actuator connects the power supply to the at least one sounder and produces an alarm audible to the vehicle's driver.

2. The alarm arrangement according to claim 1, wherein said first and second vertical stanchions each comprise a weighted base and a vertical member of adjustable height rising from said weighted base.

3. The alarm arrangement according to claim 1, wherein said anchor members each include a C-clamp secured to the associated stanchion, a D-ring secured by said C-clamp, and a double-ended snap-hook secured to the associated D-ring.

4. The alarm arrangement according to claim 1, wherein said tensioner spring has one end secured to the double-ended snap-hook of said second anchor member, and said release ring secures a second end of the tensioner spring to the second end of said flexible inextensible cable.

5. The alarm arrangement according to claim 1, wherein said flexible inextensible cable is a wire cable of a nominal 30-foot length, and having a loop of wire formed at each end.

6. The alarm arrangement according to claim 5, wherein the flexible inextensible cable comprises a plurality of visibility pennants disposed at intervals therealong.

7. The alarm arrangement according to claim 1, wherein said actuator cable is connected to the second end of said flexible inextensible cable.

8. The alarm arrangement according to claim 1, wherein said power source includes a rechargeable battery maintaining power at a predetermined volage level, and a solar generator providing electrical charging current to said rechargeable battery.

9. The alarm arrangement according to claim 1, wherein said at least one alarm sounder includes a pair of acoustic sounders.

10. The alarm arrangement according to claim 9, wherein the at least one acoustic sounder includes at least one light-generating flasher.
